(19) United States
(12) Patent Application Publication
(10) Pub. No.: US 2020/0045426 A1
(43) Pub. Date: Feb. 6, 2020

(54) SPEAKER

(71) Applicant: AAC ACOUSTIC TECHNOLOGIES (SHENZHEN) CO., LTD., SHENZHEN (CN)

(72) Inventors: Wei Song, Shenzhen (CN); Fan Zhang, Shenzhen (CN)

(21) Appl. No.: 16/527,067

(22) Filed: Jul. 31, 2019

(30) Foreign Application Priority Data
Aug. 3, 2018 (CN) 201821252584.1

(51) Int. Cl. H04R 7/18; H04R 7/12; H04R 9/02; H04R 9/04; H04R 9/06

(52) U.S. Cl. CPC H04R 7/18; H04R 7/127; H04R 9/025; H04R 2400/11; H04R 9/06; H04R 2499/11; H04R 9/045

(57) ABSTRACT

The present disclosure provides a speaker. The speaker includes a metal basket having an accommodating space, a vibration system and a magnetic circuit system that are accommodated in the accommodating space. The vibration system includes a first diaphragm configured to vibrate and produce sound and connected to the metal basket. The metal basket includes a basket body and a step portion extending from one end of the basket body close to the first diaphragm towards a direction away from the accommodating space in a bending manner, and the first diaphragm is accommodated in the accommodating space and an edge of the first diaphragm is fixed to the step portion.

### TECHNICAL FIELD

The present disclosure relates to electroacoustic conversion technology, and in particular, to a speaker.

### BACKGROUND

In recent years, with a rapid development of mobile communication technologies, customers have more access to mobile communication devices having a voice function, for example, portable phones, handheld game machines, and laptop computers. Quality of a designed speaker as a voice playing device directly influences a voice performance of products such as mobile communication devices. To meet a market demand for thin speakers having higher sound quality, higher requirements are imposed on assembly stability and cost control of speakers.

In related technologies, a basket of a speaker is made of plastics, which causes high costs, poor strength, and many structural limitations due to molding conditions. Moreover, a first diaphragm and the basket are fixed by gluing. To ensure connection stability of the first diaphragm, a fixing portion of the first diaphragm needs to be bent before being glued to a side wall of the basket, leading to high process complexity and high costs.

Therefore, it is necessary to provide a new speaker to resolve the foregoing limitations.

### BRIEF DESCRIPTION OF THE DRAWINGS

To clearly illustrate technical solutions in embodiments of the present disclosure, drawings used in the description of the embodiments are briefly described below. Obviously, the drawings in the following description are only some embodiments of the present disclosure, and other drawings can be obtained by those of ordinary skill in the art according to these drawings without creative efforts.

FIG. 1 is a schematic three-dimensional structural view of a speaker in the present disclosure;

FIG. 2 is a structural exploded view of the speaker shown in FIG. 1;

FIG. 3 is a sectional view of the speaker along an A-A line shown in FIG. 1;

FIG. 4 is an enlarged view of an area B shown in FIG. 3; and

FIG. 5 is a sectional view of the speaker along a C-C line shown in FIG. 1.

### DETAILED DESCRIPTION

Technical solutions in embodiments of the present disclosure are clearly and completely described with reference to drawings in the embodiments of the present disclosure. Obviously, the embodiments described are only some rather than all embodiments of the present disclosure. All other embodiments obtained by those of ordinary skill in the art based on the embodiments of the present disclosure without creative efforts shall fall within the protection scope of the present disclosure.

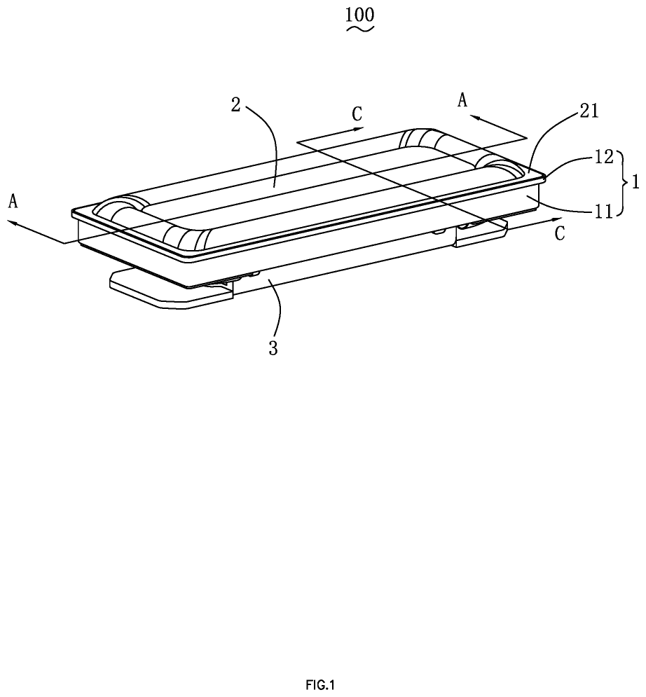

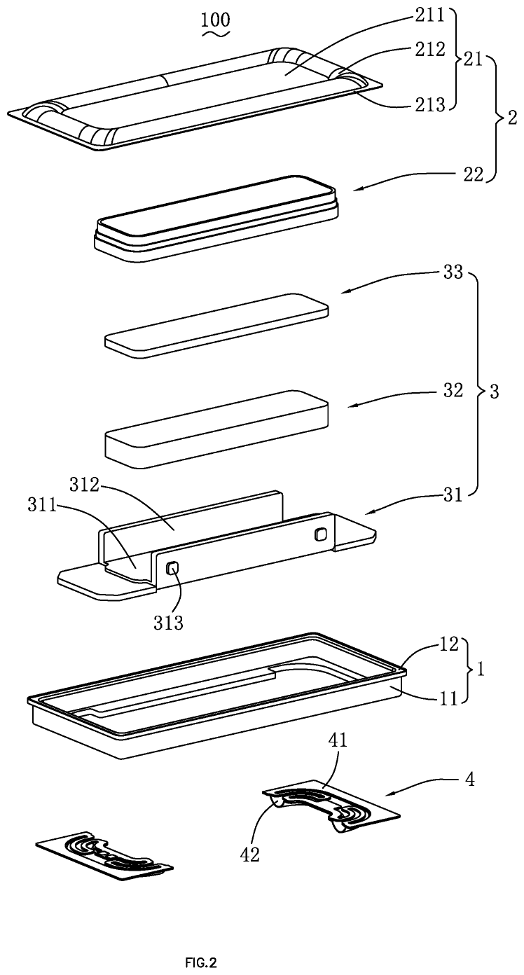

Referring to FIG. 1 and FIG. 2, the present disclosure provides a speaker 100. The speaker 100 includes a metal basket 1 having an accommodating space, a vibration system 2 accommodated in the accommodating space, a magnetic circuit system 3 configured to drive the vibration system 2 to vibrate and produce sound, and a support member 4 elastically supporting the vibration system 2.

The metal basket 1 is made of a metal material and has high strength, thereby effectively protecting other components of the speaker 100. The metal basket 1 is easy to process and shape with low costs.

The metal basket 1 includes a basket body 11 defining the accommodating space and a step portion 12 extending from one end of the basket body 11 toward a direction away from the accommodating space in a bending manner. The basket body 11 and the step portion 12 are integrally formed.

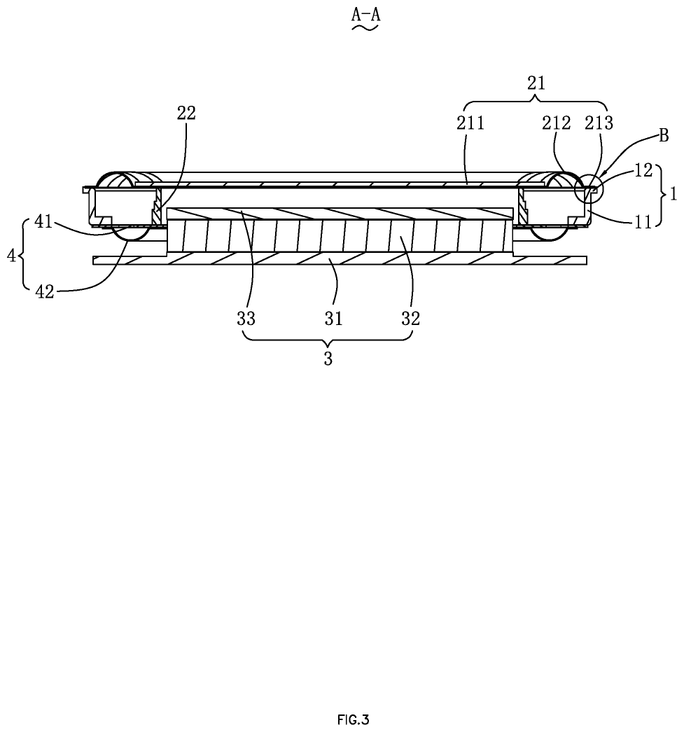

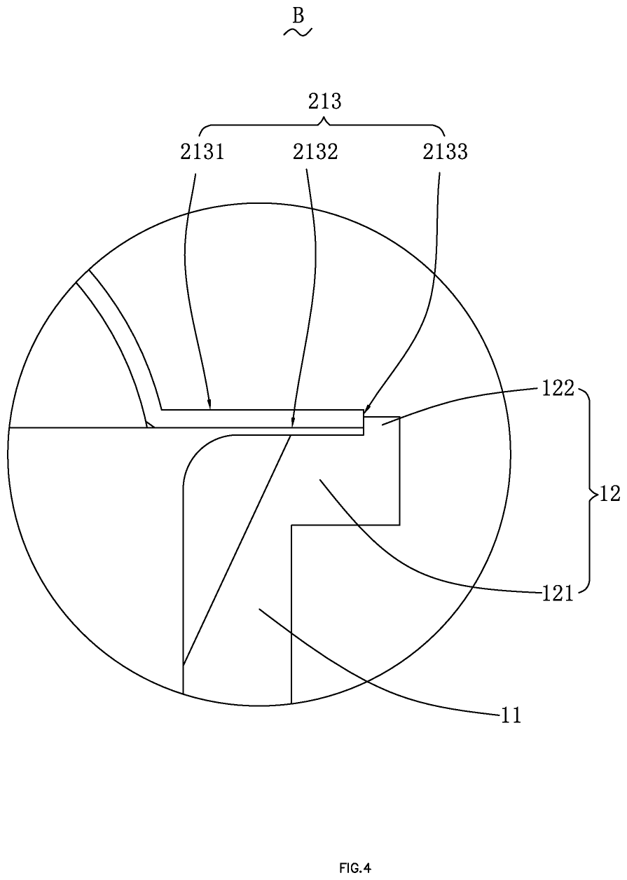

Referring to FIG. 3 and FIG. 4, specifically, the step portion 12 includes a bottom wall 121 connected to the basket body 11, and a side wall 122 bent and extending from one end of the bottom wall 121 away from the accommodating space toward a direction away from the bottom wall 121. The side wall 122 and the bottom wall 121 form a stepped structure having a receiving space together.

The vibration system 2 is configured to vibrate and produce sound. Specifically, the vibration system 2 includes a first diaphragm 21 configured to vibrate and produce sound and a voice coil 22 located below the first diaphragm 21 and configured to drive the first diaphragm 21 to vibrate and produce sound.

The first diaphragm 21 is accommodated in the accommodating space and an edge of the first diaphragm 21 is fixed to the step portion 12. It should be understood that the first diaphragm 21 is received in the receiving space and fixed to the bottom wall 121 by glue. Specifically, the first diaphragm 21 includes a dome portion 211 located in the middle and disposed facing to the voice coil 22, a folded ring portion 212 surrounding the dome portion 211, and a fixing portion 213 extending from the folded ring portion 212 in a direction away from the dome portion 211. The dome portion 211 is configured to enhance vibration of the first diaphragm 21. The folded ring portion 212 is connected between the dome portion 211 and the fixing portion 213. A cross-section of the edge portion 212 has an arc-shaped structure protruding in a direction away from the metal basket 1. The fixing portion 213 is fixed to the bottom wall 121 by glue.

The fixing portion 213 includes an upper surface 2131 away from the bottom wall 121, a lower surface 2132 disposed opposite to the upper surface 2131, and a side surface 2133 connecting the upper surface 2131 and the lower surface 2132. Specifically, the lower surface 2132 abuts against the bottom wall 121, and the side surface 2133 abuts against the side wall 122.

The basket body 11 is in a shape of a rectangular frame. The step portion 12 is disposed around the basket body 11, and the bottom wall 121 is lower than the side wall 122, so that the bottom wall 121 and the side wall 122 may form a recess, thereby facilitating positioning the first diaphragm 21 when the first diaphragm 21 is fixed and therefore improving efficiency for fixing the first diaphragm 21.

Further, the fixing portion 213 and the step portion 12 are fixed by gluing. It should be understood that the bottom wall 121 is formed by bending the basket body 11, so that the gluing area is enlarged, that is, a contact area between the fixing portion 213 and the step portion 12 is increased, thereby achieving a firm connection.

Still further, the side wall 122 and the bottom wall 121 may form the stepped structure together which has a receiving space, the fixing portion 213 is correspondingly received in the receiving space, and the side wall 122 limits a movement of the fixing portion 213, thereby further enhancing connection stability of the first diaphragm 21.

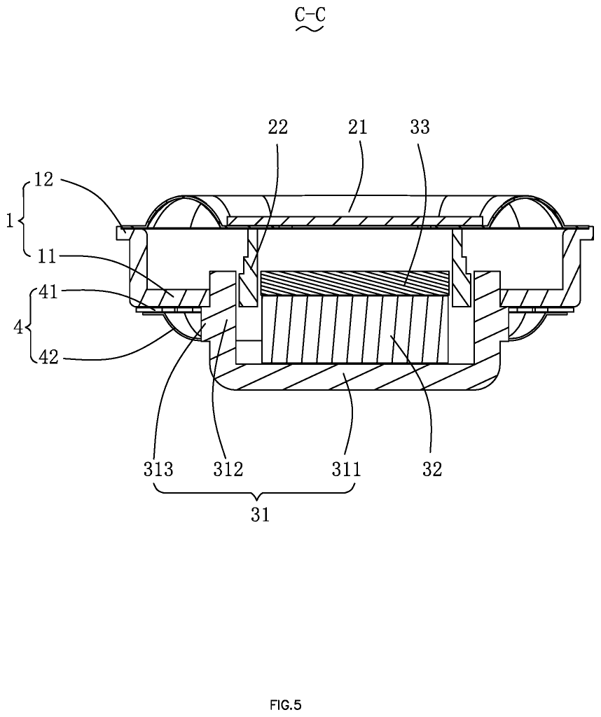

Referring to FIG. 5, the magnetic circuit system 3 is configured to drive the vibration system 2 to vibrate and produce sound. Specifically, the magnetic circuit system 3 includes a yoke 31 fixed to the basket body 11, a magnetic steel 32 assembled in the middle of the yoke 31, and a pole core 33 attached to a surface of the magnetic steel 32. The magnetic steel 32 and the yoke 31 form a magnetic gap together, and the voice coil 22 is suspended in the magnetic gap. The pole core 33 is made of a magnetic conductive material and acts as a magnetic conductor.

Further, the yoke 31 is bowl-shaped, and includes a bottom plate 311 bearing the magnetic steel 32, a side plate 312 bent and extending from two ends of the bottom plate 311 towards the vibration system 2, and a support portion 313 extending outward from one end of the side plate 312 away from the vibration system 2 and configured to support the metal basket 1. The side plate 312 and the magnetic steel 32 are separated from each other to form the magnetic gap. An outer surface of the basket body 11 abuts against an upper surface of the support portion 313. It should be understood that the basket body 11 is fixed to the side plate 312. The support portion 313 is provided not only to enlarge the contact area between the basket body 11 and the yoke 31 to increase stability, but also to be used to bear a weight of the metal basket 1 to prevent the metal basket 1 from falling and detaching from the yoke 31, thereby improving reliability of the speaker 100.

In this embodiment, the yoke includes two side plates 312 and four support portions 313, and each of the side plates 312 is provided with two support portions 313 which are symmetrical to each other, providing an aesthetically appealing structure. The four support portions 313 can evenly distribute the weight of the metal basket 1, so that the stability of the support portions 313 can be ensured.

Referring to FIG. 3 and FIG. 5, the support member 4 is located below the voice coil 22 and elastically supports the voice coil 22. The support member 4 is fixed on an outer surface of the basket body 11 and is disposed separately from the bottom plate 311. It should be understood that, the support member 4 is disposed outside the accommodating space of the metal basket 1, not to occupy space inside the metal basket 1, so that a volume of the metal basket 1 can be reduced to meet a requirement for miniaturization of the speaker 100.

Specifically, the support member 4 includes a flexible circuit board 41 connected to the voice coil 22 and configured to electrically connect the voice coil 22 and an external circuit, and a second diaphragm 42 fixed to one side of the flexible circuit board 41 away from the voice coil 22.

The second diaphragm 42 is disposed opposite to the first diaphragm 21, is configured to enhance vibration of the first diaphragm 21, and can prevent polarization of the first diaphragm 21, so as to improve acoustic performance of the speaker 100.

Compared with the related technologies, with respect to the speaker 100 in the present disclosure, the metal basket 1 includes a basket body 11 and a step portion 12 extending from one end of the basket body 11 toward a direction away from the accommodating space in a bending manner, and the step portion 12 is configured to correspondingly receive the first diaphragm 21. The step portion 12 is provided to facilitate positioning the first diaphragm 21 when the first diaphragm 21 is fixed, enlarge the contact area between the first diaphragm 21 and the basket 1, and limit a movement of the first diaphragm 21, thereby achieving firm connection, simple structure, and low costs.

The above descriptions are merely embodiments of the present disclosure, and it should be noted that those of ordinary skill in the art can make improvements without departing from the inventive concept of the present disclosure, and all such improvements shall fall within the protection scope of the present disclosure.

What is claimed is:

1. A speaker, comprising a metal basket having an accommodating space, a vibration system and a magnetic circuit system that are accommodated in the accommodating space, wherein the vibration system comprises a first diaphragm configured to vibrate and produce sound and connected to the metal basket, the metal basket comprises a basket body defining the accommodating space and a step portion extending from one end of the basket body close to the first diaphragm toward a direction away from the accommodating space in a bending manner, and the first diaphragm is accommodated in the accommodating space and an edge of the first diaphragm is fixed to the step portion.

2. The speaker according to claim 1, wherein the step portion comprises a bottom wall connected to the basket body and a side wall bent and extending from one end of the bottom wall away from the accommodating space towards a direction away from the bottom wall, wherein the side wall and the bottom wall define the receiving space together, and the edge of the first diaphragm is correspondingly received in the receiving space and fixed to the bottom wall by glue.

3. The speaker according to claim 2, wherein the first diaphragm comprises a dome portion in the middle, a folded ring portion surrounding the dome portion and a fixing portion extending from the folded ring portion in a direction away from the dome portion, and the fixing portion is fixed to the bottom wall by glue.

4. The speaker according to claim 3, wherein the fixing portion comprises an upper surface away from the bottom wall, a lower surface disposed opposite to the upper surface, and a side surface connecting the upper surface and the lower surface, wherein the lower surface abuts against the bottom wall, and the side surface abuts against the side wall.

5. The speaker according to claim 1, wherein the basket body and the step portion are integrally formed.

6. The speaker according to claim 1, wherein the vibration system further comprises a voice coil located below the first diaphragm and configured to drive the first diaphragm to vibrate and produce sound, the speaker further comprises a support member located below the voice coil and elastically supporting the voice coil, wherein one end of the support member is fixed to the basket body, and the other end of the support member is fixed to the voice coil.

7. The speaker according to claim 6, wherein the support member is fixed on an outer surface of the basket body.

8. The speaker according to claim 6, wherein the magnetic circuit system comprises a yoke fixed to the basket body, a magnetic steel assembled to the yoke, and a pole core attached to a surface of the magnet, the magnet and the yoke form a magnetic gap together, and the voice coil is suspended in the magnetic gap.

9. The speaker according to claim 8, wherein the yoke is bowl-shaped and comprises a bottom plate bearing the magnetic steel, a side plate bent and extending from two ends of the bottom plate toward the vibration system, and a support portion extending outward from one end of the side plate away from the vibration system and configured to support the metal basket, the magnetic steel and the side plate are separated apart from each other to form the magnetic gap, and an outer surface of the basket body abuts against an upper surface of the support portion.

10. The speaker according to claim 9, wherein the yoke comprises two side plates and four supporting portions, the two side plates are symmetrically disposed about a central axis line of the bottom plate, and each of the side plates is provided with two supporting portions which are symmetrical to each other.
